(19) United States
(12) Patent Application Publication
(10) Pub. No.: US 2009/0000127 A1
(43) Pub. Date: Jan. 1, 2009

(54) MULTIPURPOSE SHEARS

(76) Inventor: Christopher Smith, Suffolk, VA (US)

Correspondence Address: WILLIAMS MULLEN, 222 CENTRAL PARK AVENUE, SUITE 1700, VIRGINIA BEACH, VA, 23462, US

(21) Appl. No.: 12/138,750

(22) Filed: Jun. 13, 2008

Related U.S. Application Data
(60) Provisional application No. 60/937,220, filed on Jun. 26, 2007.

(51) Int. Cl. B26B 13/00; B26B 11/00

(52) U.S. Cl. 30/134; 30/254; 7/158

(57) ABSTRACT

Multi-purpose shears adapted to include structure that enables rapid and effective cutting of sheet fabric as well as tough fabric. A U-shaped housing is positioned on a loop grip of the shears, the housing having an insertion slot defining an opening at one end and at least one blade having a cutting edge mounted within the housing. The blades are positioned within the housing so as to present a cutting edge obliquely to the insertion slot, so as to cut or slice material inserted into the insertion slot. The insertion slot is generally configured in a direction that permits ergonomic handling of the shears for both snipping and for slicing. The opening may be oriented in a proximal direction relative to the operator, so that the operator may snip in one direction and slice in the reverse direction.

### RELATED PATENT APPLICATIONS

This application claims benefit of the priority date of the U.S. Provisional Patent Application Ser. No. 60/937,220, filed on Jun. 26, 2007, and entitled “Trauma Shears,” inventor Christopher Smith, which is hereby incorporated.

### STATEMENT REGARDING FEDERALLY SPONSORED RESEARCH OR DEVELOPMENT

Not applicable.

### FIELD OF THE INVENTION

The present invention relates to shears serving multiple purposes. In particular, the present invention relates to shears having an edge tool suitable for use in medical traumas, outdoor sports, crafts, etc.

### BACKGROUND OF THE INVENTION

Shears are a form of hand-held cutting tool, which are commonly used to cut material, paper, fabric, etc. The shears include a pair of crossing arms or blades that are pivotally mounted. One end of each arm has a shearing edge while the other end typically includes a loop shaped hand grip. The arms are mounted so that the shearing edges face each other inwardly. The pivot forms a fulcrum by which operation of the hand grips leverages the blades to shear the fabric or other materials.

Trauma shears are used to cut away a person's clothing to provide access for medical treatment. This tool is typically strong and durable, and is intended to shear through hems, pockets, layered fabric, straps, thick plackets, etc. Although specialization has led to refinement of a strong design capable of cutting a variety of tough materials, it has also limited the scope of applicability of such shears.

In some cases, for example, the speed of cutting may be more important than the strength of the shearing effect. The repetitive snipping involved in hand shearing can be time consuming. The blades of trauma shears and their strong design may not cut through certain sheet fabrics as quickly as required. The requirement for toughness in some shears may also lead to the use of durable but duller blades, which can be ineffective or inefficient when used to slice fabric. Further, the requirement that the blades of trauma shears be suitable for use adjacent to a person's skin when underneath clothing means that the blade ends are often short or limited beyond the pivot point. This limited length can further increase the time of cutting.

One approach to this problem has been for medical personnel to carry or store multiple types of shears, scissors, or knives. Trauma shears may be used for making an initial cut or cutting through seams and thick layers, while a different slicing or cutting tool might be used for cutting sheets of lighter material. Of course, time is lost while one tool is stored or set aside and the other tool is located and applied to the fabric. Some have attempted to solve such a problem by creating multi-function hand tools as may be seen in U.S. Pat. No. 6,698,049, which is somewhat configured like a modified pocket knife. Even with this approach, medical personnel must still pause from cutting in order to reconfigure the multi-function tool to access a different device.

Beyond a clear application for use in medical trauma, as described above, it is contemplated that a device resolving these problems could have beneficial application for a variety of other activities, such as outdoor sports (e.g., fishing, hunting, climbing, skydiving, etc.), upholstery and other textile work, clothing assembly, crafts, etc.

Thus, it would be desirable to have a multi-purpose shear that is capable of quickly slicing sheet fabric as well as snipping through tough fabric. Of course, such a design should be safe and carry a low risk of cutting the user or any possible patient.

### BRIEF SUMMARY OF THE INVENTION

The present invention is a pair of multi-purpose shears that include structure that enables the rapid and effective cutting of sheet fabric as well as tough fabric.

An embodiment of the multi-purpose shears of the present invention has a first elongated member with a distal shearing end and proximal gripping end, wherein the shearing end has a downwardly facing shearing edge and the gripping end defines a first loop adapted to receive one or more fingers and a second elongated member with a distal shearing end and a proximal gripping end, wherein the shearing end has an upwardly facing shearing edge and the gripping end defines a second loop adapted to receive a thumb. A pivot located between the shearing end and the gripping end of the first member connects the first member to the second member, at a corresponding point between the shearing end and the gripping end of the second member, in an adjacent, complementary, and crossing manner, so that the shearing end of the first member is capable of pivoting higher than the shearing end of the second member, the gripping end of the first member is lower than the gripping end of the second member. The shearing edge of the first member is thus adjacent and opposing to the shearing edge of the second member. Opening the gripping ends relative to each other opens the shearing ends away from each other in an opposing manner and closing the gripping ends relative to each other closes the shearing ends in an adjacent manner. Optionally, the first and second members may be angled obtusely at a corresponding point near the pivot to enable operation of the shears while the second member is proximate to a flat surface.

A U-shaped housing is positioned on the first or second loop. The U-shaped housing defines an insertion slot having an opening at one end and has at least one blade having a cutting edge mounted within the housing, with the blade positioned within the housing so as to present the cutting edge obliquely to the insertion slot to cut material inserted into the insertion slot. Thus, the U-shaped housing may be positioned on the first or second loop at a desired orientation to that loop. The housing may be positioned relative to that loop so as to orient the insertion slot substantially tangentially to that loop. Alternatively, the housing may be positioned relative to that loop so as to orient the insertion slot at an angle ranging from parallel with the shearing ends with the opening facing in the distal direction to perpendicular with the first gripping end with the opening facing downwardly. In a different embodiment, the housing may be positioned relative to that loop so as to orient the insertion slot at an angle ranging from parallel with the shearing ends with the opening facing in the proximal direction to perpendicular with the that gripping end with the opening facing upwardly.

In another embodiment, the shearing end of the second member further comprises a clothes lifter at its distal tip. Optionally, the clothes lifter at the distal tip may further include a recessed band cutting edge.

The U-shaped housing is integrated fully into the loop on which it is positioned, or positioned detachably on that loop. Optionally, the at least one blade may be removably mounted within the housing with the U-shaped housing positioned detachably on the first or second loop. In another embodiment, the U-shaped housing may be integrated into the first or second loop and the U-shaped housing and that loop are longitudinally split into at least two pieces, further comprising at least one housing fastener configured to fasten the two pieces of the U shaped housing together in a detachable manner, and at least one member fastener configured to detachably fasten the two pieces of the first loop together and to the elongated member. In an alternate embodiment, the U-shaped housing may be longitudinally split into two pieces, and further include at least one housing fastener configured to fasten the two pieces together in a detachable manner, and the U-shaped housing may be adapted to surround a portion of the first or second loop so that the housing may be positioned detachably on that loop.

In another embodiment, the U-shaped housing may be longitudinally split into two pieces and have at least one housing fastener configured to fasten the two pieces together in a detachable manner, the U-shaped housing being adapted to surround a portion of the first or second loop so that the housing may be positioned detachably on that loop, and wherein the at least one blade may be removably mounted within the housing and the housing is configured so as to define a compartment for storage of blades when the two pieces are fastened together.

In a further embodiment, the first or second loop may have receiving structure defining a receiving surfaces and the U shaped housing may have connecting surfaces adapted to detachably mate with the receiving surfaces so that the housing may be positioned detachably on the first or second loop.

In a further embodiment, the multi-purpose shears of the present invention may have a first elongated member with a distal shearing end and proximal gripping end, wherein the shearing end has a downwardly facing shearing edge and the gripping end defines a first loop adapted to receive one or more fingers and a second elongated member with a distal shearing end and a proximal gripping end, wherein the shearing end has an upwardly facing shearing edge and the gripping end defines a second loop adapted to receive a thumb. A pivot located between the shearing end and the gripping end of the first member connects the first member to the second member, at a corresponding point between the shearing end and the gripping end of the second member, in an adjacent, complementary, and crossing manner so that the shearing end of the first member is capable of pivoting higher than the shearing end of the second member, the gripping end of the first member is lower than the gripping end of the second member, the shearing edge of the first member is adjacent and opposing the shearing edge of the second member. Opening the gripping ends relative to each other opens the shearing ends away from each other in an opposing manner and closing the gripping ends relative to each other closes the shearing ends in an adjacent manner. A UL-shaped housing is positioned on the first or second loop. The U-shape housing defines an insertion slot having an opening at one end and at least one blade having a cutting edge removably mounted within the housing. The blade is positioned within the housing so as to present the cutting edge obliquely to the insertion slot to cut material inserted into the insertion slot. The U-shaped housing may be longitudinally split into two pieces, further comprising at least one housing fastener configured to fasten the two pieces together in a detachable manner, with the U-shaped housing being adapted to surround a portion of the first or second loop so that the housing may be positioned detachably on the that loop. Optionally, the housing may be configured further to define a compartment for storage of blades when the two pieces are fastened together. The housing may be positioned on the first or second loop with the insertion slot relative to that loop so as to orient the insertion slot substantially tangentially to the loop.

### BRIEF DESCRIPTION OF THE SEVERAL VIEWS OF THE DRAWINGS

FIG. 1 is a side view of an embodiment of the present invention.

FIGS. 2a and 2b depict embodiments of the present invention.

FIG. 3 depicts embodiments of the present invention.

FIG. 4 depicts an embodiment of the present invention.

FIG. 5 depicts an embodiment of the present invention with a detachably mounted housing.

FIG. 6 depicts an embodiment of the present invention with a detachably mounted housing.

FIG. 7a depicts an embodiment of the present invention with a detachably mounted housing; FIG. 7b depicts a proximal view of the housing.

FIG. 8a depicts a side view of an embodiment of the present invention and

FIG. 8b is a detail of that embodiment.

### DETAILED DESCRIPTION OF THE INVENTION

The present invention is a pair of multi-purpose shears that have the additional structure to enable a rapid, safe, and effective cutting of both sheet fabric and tough or layered fabric.

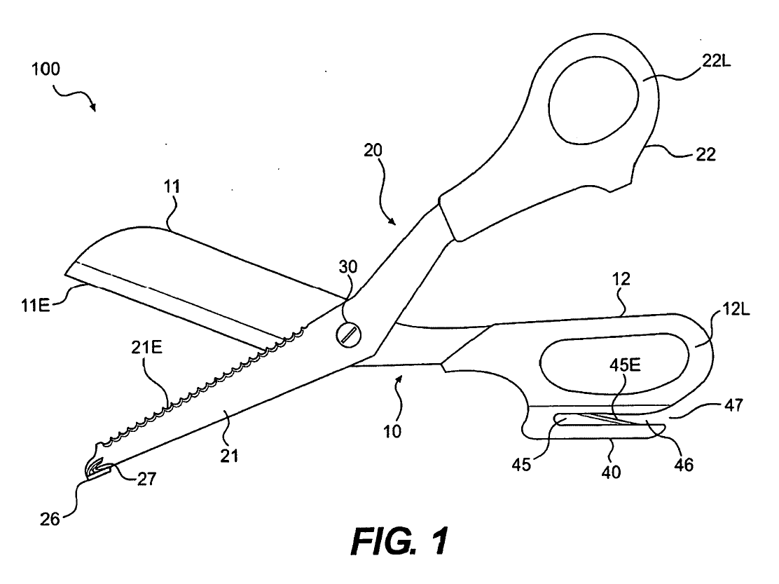

In reference to FIGS. 1-8, shears 100 may be viewed as having a first elongated member 10 or blade and second elongated member 20 or blade. First member 10 includes a first shearing end 11 and first gripping end 12 or handle, while second member includes corresponding second shearing end 21 and second gripping end 22 or handle.

With initial reference to FIG. 1, for the purposes of this description, the term “distal” or distally refers generally to a direction away or more distant from a user of the shears 100, while the term “proximal” or proximally refers to a direction toward or more near to a user of the shears 100, when a user is cutting away from the user. Thus, the first elongated member 10 with a distal first shearing end 11 and proximal first gripping end 12, may be distinguished by a first shearing end 11 having a downwardly facing shearing edge 11E; its first gripping end 12 defines a first loop 12L adapted to receive one or more fingers. Similarly, in asymmetric fashion, second elongated member 20 with a distal second shearing end 21 and a proximal second gripping end 22, may be distinguished by a second shearing end 21 having an upwardly facing shearing edge 21E; its second gripping end 22 defines a second loop 22L adapted to receive a thumb. This configuration supports right handed use; the shears 100 of the present invention should be construed as extended to configurations supporting left handed use as well.

Elongated members 10, 20 are mounted together at pivot 30 to shear or snip fabric. Thus, this pivot 30 is located between the first shearing end 11 and the first gripping end 12 of the first member 10, and connects the first member 10 to the second member 20 at a corresponding point between the second shearing end 21 and the second gripping end 22 of the second member 20. Thus, for this embodiment the elongated members 10, 20 are pivotally mounted in an adjacent, complementary, and crossing manner so that the first shearing end 11 of first elongated member 10 is capable of pivoting higher than the second shearing end 21 of the second elongated member 20. Conversely, the first gripping end 12 of the first elongated member 10 is lower than the second gripping end 22 of the second elongated member 20. The shearing edge 11E of the first elongated member 10 is adjacent and opposing the shearing edge 21E of second elongated member 20. In this way, opening the gripping ends 12, 22 relative to each other opens the shearing ends 11, 21 away from each other in an opposing manner and closing the gripping ends 12, 22 relative to each other closes the shearing ends 11, 21 in an adjacent manner.

For this embodiment, first elongated member 10 may be considered as an upper member, for convention of reference, to the extent that its first shearing end 11 pivots within an upper relative area; conversely, second elongated member 20 may be considered a lower member as its second shearing end 21 pivots within a lower relative area. However, the present invention should be construed as also encompassing embodiments in which first and second members 10, 20 may rest substantially adjacent to each other when trauma shears are in a fully closed position.

The elongated first and second elongated members 10, 20 may preferably, though not necessarily, be angled obtusely at corresponding points near the pivot 30 to enable operation of the shears 100 while the second elongated member 20 is proximate to a flat surface, such as a table or the skin of a patient (not shown) for embodiments of shears 100 used as trauma shears. In other words, this allows operation of the shears 100 with the second shearing end 21 of the second elongated member 20 held proximate or against the surface; the second shearing end 21 of lower second elongated member 20 may be slid underneath fabric or clothing while the upper first elongated member 10 is cycled to shear or snip the material or clothing. Thus, in some types of operation, the elongated members 10, 20 form a mouth that can open and close by motion of the upper first elongated member 10 relative to second elongated member 20. An effective angle for embodiments of shears 100 as trauma shears is 150 degrees. However, a wide variety of obtuse angles may be used, taking into consideration the application, desired leverage, wrist angle, freedom of movement relative to any surface, and freedom of operation.

With reference to FIG. 1, optionally the second shearing end 21 of the lower second elongated member 20 may have a blunt tip, and also optionally may include a lift lip 26 that can be used to lift material or clothing into the mouth of the shears 100 formed by the distal shearing ends 11, 21. For embodiments of shears 100 used in trauma, bluntness may prevent inadvertent scratching or puncturing of a patient. The lift lip 26 may optionally include a recessed cutting edge 27 that may be used in a pulling fashion to remove or cut strings, threads, or thin hospital-type identification bands.

As may be seen in FIG. 1, one or both of the distal shearing ends 11, 21 may be serrated to improve the grip on material or cloth during snipping. Given the value of such shears 100 during trauma or medical response, preferably such embodiments of shears 100 may be manufactured from durable and high quality materials, such as stainless steel, at least for the distal shearing ends 11, 21.

As noted above, the shears 100 of the present invention may be adapted for use with either the right or the left hand, as may be desired. Such adaptation from a right hand to the left generally involves a shift of asymmetric features to accommodate the thumb and fingers of the left hand.

Another aspect is a generally U-shaped housing 40 positioned on one of gripping ends 12, 22, at the point forming loops 12L or 22L. FIGS. 1-8 depict a variety of embodiments. With reference to FIG. 1, U-shaped housing 40 defines an insertion slot 46 defining an opening 47 at one end and at least one blade 45 having a cutting edge 45E mounted within U-shaped housing 40. The at least one blade 45 is positioned within the U-shaped housing 40 so as to present a cutting edge 45E obliquely to the insertion slot 46, so as to cut or slice material inserted into the insertion slot 46. The insertion slot 46 is generally configured in a direction that permits ergonomic handling of the shears 100 for both snipping (i.e., using distal shearing ends 11, 21) and for slicing (i.e., using blade 45). For example, one embodiment of the shears 100 presents opening 47 facing in the proximal direction relative to the first and second elongated members 10, 20, so that an operator may snip in one direction and slice in the reverse direction. Thus, the insertion slot 46 can be oriented substantially tangentially to loops 12L or 22L, as applicable.

The U-shaped housing 40 may be positioned relative to a respective one of the gripping ends 12, 22, so as to orient the insertion slot 46 at an angle ranging anywhere from parallel with the mounting gripping end 12 or 22, with the opening 47 facing in the distal direction, to perpendicular with the mounting gripping end 12 or 22 with the opening 47 facing downwardly. Preferably, though not necessarily, for embodiments of shears 100 used as trauma shears, U-shaped housing 40 is mounted on first gripping end 12. In another example, the U-shaped housing 40 may be positioned relative to the mounting gripping end 12 or 22 so as to orient the insertion slot 46 at an angle ranging from parallel with the shearing ends 11 or 21 with the opening 47 facing in the proximal direction to perpendicular with the mounting gripping end 12 or 22 with the opening 47 facing upwardly. FIG. 1 depicts shears 100 with U-shaped housing 40 mounted on first gripping end 12 at first loop 12L, with opening 47 facing proximally and insertion slot 46 somewhat parallel to first gripping end 12. For embodiments of shears 100 used as trauma shears, the Applicant has discovered this configuration to be effective, easy to use, and quick to operate.

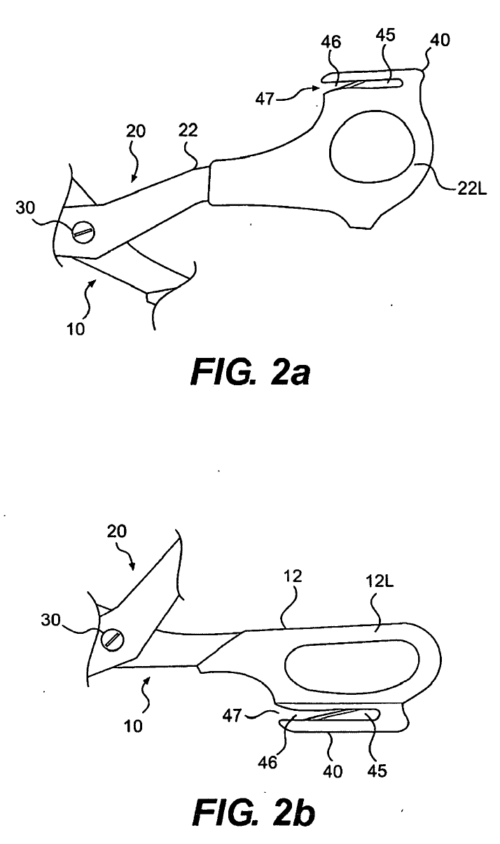

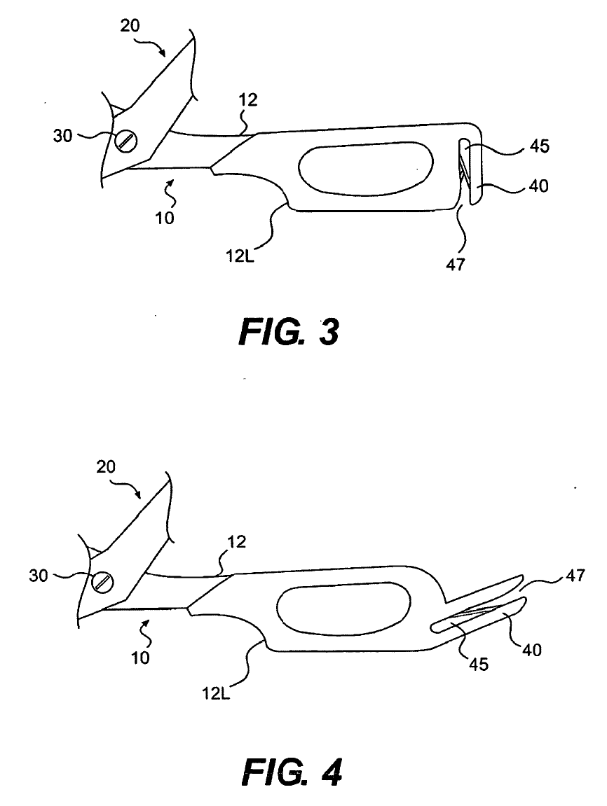

FIGS. 2a and 2b depict shears 100 with the orientation of U-shaped housing 40 reversed so that opening 47 faces distally. In FIG. 2a, U-shaped housing 40 is positioned on second loop 22L of elongated member 20. FIG. 2b depicts U-shaped housing 40 positioned on first loop 12L of elongated member 10. FIG. 3 depicts shears 100 with a different orientation such that opening 47 facing downwardly which, similarly, could be reversed such that opening 47 would face upwardly (not shown). Optionally, as also shown in FIG. 3, is an embodiment of shears 100 in which positioned within U-shaped housing 40 is at least one blade 45 comprising two blades 45. Such an embodiment provides enhanced cutting or slicing effect. FIG. 4 depicts an embodiment of shears 100 in which U-shaped housing 40 is mounted on first gripping end 12 in a manner so that insertion slot 46 is somewhat parallel to first gripping end 12, but configured differently from the embodiment of FIG. 1.

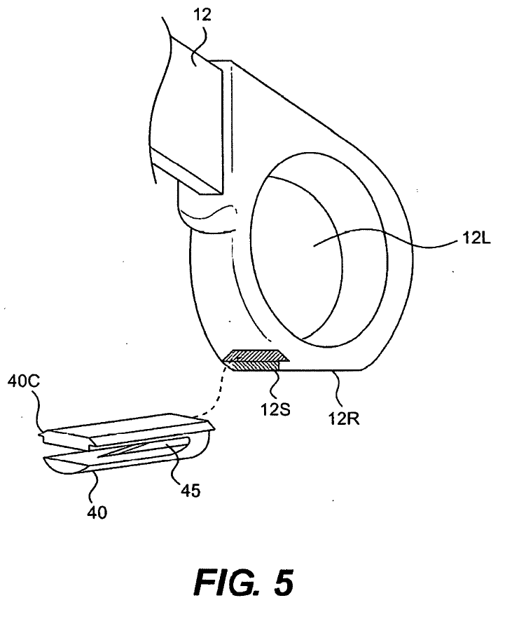

Previous figures have shown U-shaped housing 40 integrated into one of first and second loop 12L or 22L. Optionally, as shown in FIG. 5, the U-shaped housing 40 may be mounted detachably or removably on one of mounting gripping ends 12 or 22 to enable removal of the U-shaped housing 40; in some embodiments, this may enable replacement of the at least one blade 45 positioned within the U-shaped housing 40, or complete replacement of U-shaped housing 40. In this embodiment, shears 100 are shown with first gripping end 12 having receiving structure 12R with outwardly directed receiving surfaces 12S and replaceable U-shaped housing 40 having projecting connecting surfaces 40C that detachably mate with receiving surfaces 12S of receiving structure 12R. Conversely, receiving structure 12R might have inwardly projecting surfaces 12S (not shown) and U-shaped housing 40 might have inwardly directed connecting surfaces 40C for mating.

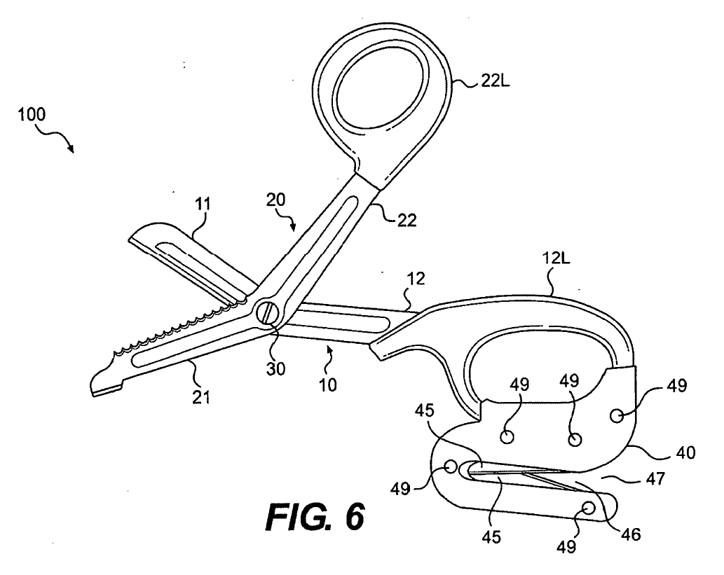

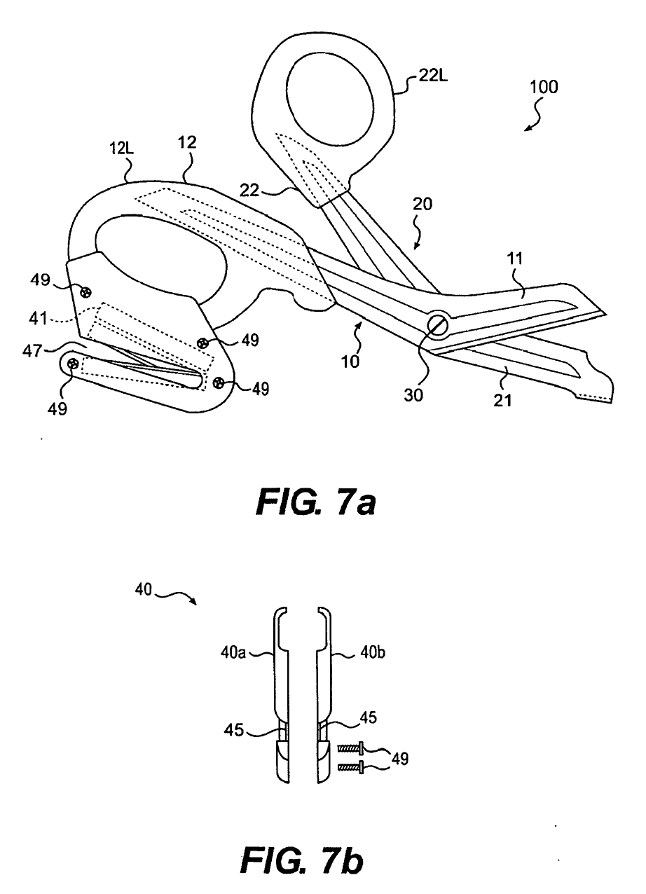

Other detachable structures may be appropriate for other embodiments of shears 100. For example, shears 100 shown in FIGS. 6 and 7a employ housing fasteners 49 for mounting a longitudinally split U-shaped housing 40 (i.e., split into two pieces 40A and 40B as shown in the proximal view of FIG. 7b) onto first loop 12L of first gripping end 12. In this case, U-shaped housing 40 may be adapted to surround a portion of the first loop 12L. Optionally, such a longitudinally split configuration of U-shaped housing 40 enables the definition of storage compartment 41 within U-shaped housing 40, which may be accessed by removal of housing fasteners 49. Optionally, blades 45 may be removably positioned within U-shaped housing 40, and such storage could be used to store replacement blades 45. Another aspect of the present invention is directed to a retrofit longitudinally split U-shaped housing 40 containing at least one blade 45, which may be detachably positioned or mounted onto one of loops 12L or 22L of conventional shears to form shears 100, as shown in FIG. 6.

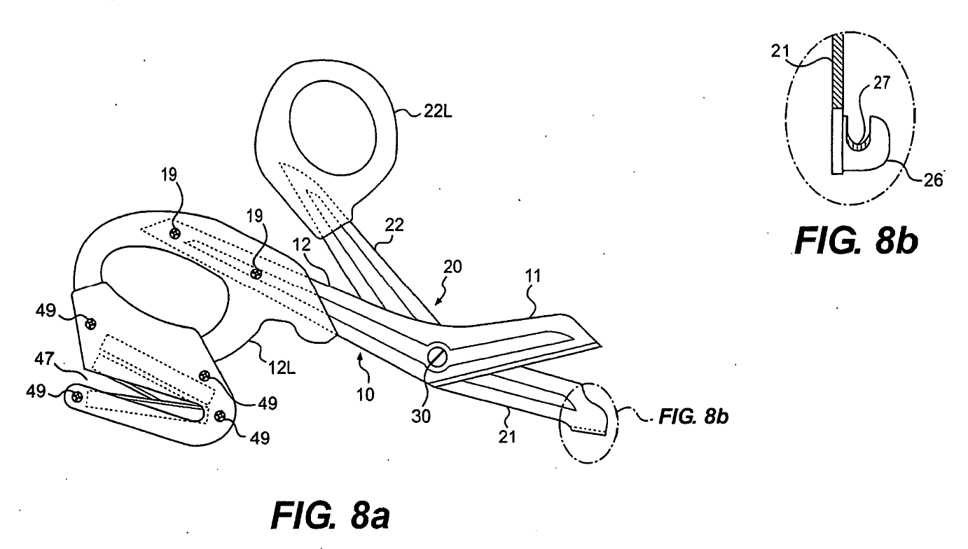

FIG. 8 shows an alternative embodiment in which U-shaped housing 40 is integrated into first loop 12L, but that such first loop 12L is similarly longitudinally split, i.e., into two pieces (not shown), and may be fastened to or removed from corresponding first gripping end 12 of elongated member 10 by member fasteners 19. With first loop 12L longitudinally split, U-shaped housing 40 is also longitudinally split, so that removal of member fasteners 19 and housing fasteners 49 enables removal of first loop 12L from first gripping end 12 of elongated member 10, and separation of the pieces (not shown) of first loop 12L. Similarly, such a configuration may be adapted for use with second loop 22L and second gripping end 22.

The above examples should be considered to be exemplary embodiments, and are in no way limiting of the present invention. Thus, while the description above refers to particular embodiments, it will be understood that many modifications may be made without departing from the spirit thereof.

What is claimed are:

1. Multi-purpose shears, comprising:
a first elongated member with a distal shearing end and proximal gripping end, wherein the shearing end has a downwardly facing shearing edge and the gripping end defines a first loop adapted to receive one or more fingers;
a second elongated member with a distal shearing end and a proximal gripping end, wherein the shearing end has an upwardly facing shearing edge and the gripping end defines a second loop adapted to receive a thumb;
a pivot located between the shearing end and the gripping end of the first member connecting the first member to the second member, at a corresponding point between the shearing end and the gripping end of the second member, in an adjacent, complementary, and crossing manner so that the shearing end of the first member is capable of pivoting higher than the shearing end of the second member, the gripping end of the first member is lower than the gripping end of the second member, the shearing edge of the first member is adjacent and opposing the shearing edge of the second member, wherein opening the gripping ends relative to each other opens the shearing ends away from each other in an opposing manner and closing the gripping ends relative to each other closes the shearing ends in an adjacent manner;
a U-shaped housing defining an insertion slot having an opening at one end and at least one blade having a cutting edge mounted within the housing, the blade positioned within the housing so as to present the cutting edge obliquely to the insertion slot to cut material inserted into the insertion slot; and
wherein the housing is positioned on the first loop with the insertion slot at a desired orientation to the first loop.

2. The multi-purpose shears according to claim 1, wherein the first and second members are angled obtusely at a corresponding point near the pivot to enable operation of the shears while the second member is proximate to a flat surface.

3. The multi-purpose shears according to claim 1, wherein the housing is positioned relative to the first loop so as to orient the insertion slot substantially tangentially to the first loop.

4. The multi-purpose shears according to claim 1, wherein the housing is positioned relative to the first loop so as to orient the insertion slot at an angle ranging from parallel with the shearing ends with the opening facing in the distal direction to perpendicular with the first gripping end with the opening facing downwardly.

5. The multi-purpose shears according to claim 1, wherein the housing is positioned relative to the first loop so as to orient the insertion slot at an angle ranging from parallel with the shearing ends with the opening facing in the proximal direction to perpendicular with the first gripping end with the opening facing upwardly.

6. The multi-purpose shears according to claim 1, wherein the shearing end of the second member further comprises a clothes lifter at the distal tip.

7. The multi-purpose shears according to claim 1, wherein the shearing end of the second member further comprises a clothes lifter at the distal tip and further wherein the clothes lifter includes a recessed band cutting edge.

8. The multi-purpose shears according to claim 1, wherein the U-shaped housing is integrated into the first loop.

9. The multi-purpose shears according to claim 1, wherein the U-shaped housing is positioned detachably on the first loop.

10. The multi-purpose shears according to claim 1, wherein the at least one blade is removably mounted within the housing and wherein the U-shaped housing is positioned detachably on the first loop.

11. The multi-purpose shears according to claim 1, wherein the U-shaped housing is integrated into the first loop and the U-shaped housing and first loop are longitudinally split into at least two pieces, further comprising at least one housing fastener configured to fasten the two pieces of the U shaped housing together in a detachable manner, and at least one member fastener configured to detachably fasten the two pieces of the first loop together and to the first elongated member.

12. The multi-purpose shears according to claim 1, wherein the U-shaped housing is longitudinally split into two pieces, further comprising at least one housing fastener configured to fasten the two pieces together in a detachable manner, and the U-shaped housing is adapted to surround a portion of the first loop so that the housing may be positioned detachably on the first loop.

13. The multi-purpose shears according to claim 1, wherein the U-shaped housing is longitudinally split into two pieces, further comprising at least one housing fastener configured to fasten the two pieces together in a detachable manner, the U-shaped housing is adapted to surround a portion of the first loop so that the housing may be positioned detachably on the first loop, and
wherein the at least one blade is removably mounted within the housing and the housing is configured so as to define a compartment for storage of blades when the two pieces are fastened together.

14. The multi-purpose shears according to claim 1, wherein the first loop further comprises receiving structure defining receiving surfaces and the U shaped housing further comprises connecting surfaces adapted to detachably mate with the receiving surfaces so that the housing may be positioned detachably on the first loop.

15. Multi-purpose shears, comprising:
a first elongated member with a distal shearing end and proximal gripping end, wherein the shearing end has a downwardly facing shearing edge and the gripping end defines a first loop adapted to receive one or more fingers;
a second elongated member with a distal shearing end and a proximal gripping end, wherein the shearing end has an upwardly facing shearing edge and the gripping end defines a second loop adapted to receive a thumb;
a pivot located between the shearing end and the gripping end of the first member connecting the first member to the second member, at a corresponding point between the shearing end and the gripping end of the second member, in an adjacent, complementary, and crossing manner so that the shearing end of the first member is capable of pivoting higher than the shearing end of the second member, the gripping end of the first member is lower than the gripping end of the second member, the shearing edge of the first member is adjacent and opposing the shearing edge of the second member, wherein opening the gripping ends relative to each other opens the shearing ends away from each other in an opposing manner and closing the gripping ends relative to each other closes the shearing ends in an adjacent manner;
a U-shaped housing defining an insertion slot having an opening at one end and at least one blade having a cutting edge mounted within the housing, the blade positioned within the housing so as to present the cutting edge obliquely to the insertion slot to cut material inserted into the insertion slot; and
wherein the housing is positioned on the second loop with the insertion slot at a desired orientation to the second loop.

16. The multi-purpose shears according to claim 15, wherein the first and second members are angled obtusely at a corresponding point near the pivot to enable operation of the shears while the second member is proximate to a flat surface.

17. The multi-purpose shears according to claim 15, wherein the housing is positioned relative to the second loop so as to orient the insertion slot substantially tangentially to the second loop.

18. The multi-purpose shears according to claim 15, wherein the housing is positioned relative to the second loop so as to orient the insertion slot at an angle ranging from parallel with the shearing ends with the opening facing in the distal direction to perpendicular with the first gripping end with the opening facing downwardly.

19. The multi-purpose shears according to claim 15, wherein the housing is positioned relative to the second loop so as to orient the insertion slot at an angle ranging from parallel with the shearing ends with the opening facing in the proximal direction to perpendicular with the first gripping end with the opening facing upwardly.

20. The multi-purpose shears according to claim 15, wherein the shearing end of the second member further comprises a clothes lifter at the distal tip.

21. The multi-purpose shears according to claim 15, wherein the shearing end of the second member further comprises a clothes lifter at the distal tip and further wherein the clothes lifter includes a recessed band cutting edge.

22. The multi-purpose shears according to claim 15, wherein the U-shaped housing is integrated into the second loop.

23. The multi-purpose shears according to claim 15, wherein the U-shaped housing is positioned detachably on the second loop.

24. The multi-purpose shears according to claim 15, wherein the at least one blade is removably mounted within the housing and wherein the U-shaped housing is positioned detachably on the second loop.

25. The multi-purpose shears according to claim 15, wherein the U-shaped housing is integrated into the second loop and the U-shaped housing and second loop are longitudinally split into at least two pieces, further comprising at least one housing fastener configured to fasten the two pieces of the U shaped housing together, and at least one member fastener configured to detachably fasten the two pieces of the second loop together and to the second elongated member.

26. The multi-purpose shears according to claim 15, wherein the U-shaped housing is longitudinally split into two pieces, further comprising at least one housing fastener configured to fasten the two pieces together in a detachable manner, and the U-shaped housing is adapted to surround a portion of the second loop so that the housing may be positioned detachably on the second loop.

27. The multi-purpose shears according to claim 15, wherein the U-shaped housing is longitudinally split into two pieces, further comprising at least one housing fastener configured to fasten the two pieces together in a detachable manner, the U-shaped housing is adapted to surround a portion of the second loop so that the housing may be positioned detachably on the second loop, and
wherein the at least one blade is removably mounted within the housing and the housing is configured so as to define a compartment for storage of blades when the two pieces are fastened together.

28. The multi-purpose shears according to claim 15, wherein the second loop further comprises receiving structure defining receiving surfaces and the U shaped housing further comprises connecting surfaces adapted to detachably mate with the receiving surfaces so that the housing may be positioned detachably on the second loop.

29. Multi-purpose shears, comprising:
a first elongated member with a distal shearing end and proximal gripping end, wherein the shearing end has a downwardly facing shearing edge and the gripping end defines a first loop adapted to receive one or more fingers;
a second elongated member with a distal shearing end and a proximal gripping end, wherein the shearing end has an upwardly facing shearing edge and the gripping end defines a second loop adapted to receive a thumb;
a pivot located between the shearing end and the gripping end of the first member connecting the first member to the second member, at a corresponding point between the shearing end and the gripping end of the second member, in an adjacent, complementary, and crossing manner so that the shearing end of the first member is capable of pivoting higher than the shearing end of the second member, the gripping end of the first member is lower than the gripping end of the second member, the shearing edge of the first member is adjacent and opposing the shearing edge of the second member, wherein opening the gripping ends relative to each other opens the shearing ends away from each other in an opposing manner and closing the gripping ends relative to each other closes the shearing ends in an adjacent manner;
a U-shaped housing defining an insertion slot having an opening at one end and at least one blade having a cutting edge removably mounted within the housing, the blade positioned within the housing so as to present the cutting edge obliquely to the insertion slot to cut material inserted into the insertion slot, wherein the U-shaped housing is longitudinally split into two pieces, further comprising at least one housing fastener configured to fasten the two pieces together in a detachable manner, the U-shaped housing being adapted to surround a portion of the first loop so that the housing may be positioned detachably on the first loop, the housing configured further to define a compartment for storage of blades when the two pieces are fastened together; and
wherein the housing is positioned on the first loop with the insertion slot at relative to the first loop so as to orient the insertion slot substantially tangentially to the first loop.
